(19) United States
(12) Patent Application Publication
(10) Pub. No.: US 2019/0331516 A1
(43) Pub. Date: Oct. 31, 2019

(54) APPARATUS AND METHOD FOR FLUID FLOW MEASUREMENT

(71) Applicant: Taylor Commercial Foodservices Inc, Rockton, IL (US)

(72) Inventors: Otley Dwight Freymiller, Rockton, IL (US); Morgan James Lowery, Sun Prairie, WI (US)

(73) Assignee: Taylor Commercial Foodservices Inc, Rockton, IL (US)

(21) Appl. No.: 16/393,682

(22) Filed: Apr. 24, 2019

Related U.S. Application Data
(60) Provisional application No. 62/663,494, filed on Apr. 27, 2018.

(51) Int. Cl. G01F 1/86; B67D 3/00; G01F 1/34; G01F 1/696

(52) U.S. Cl. CPC G01F 1/86; B67D 3/0003; G01F 1/6965; G01F 1/34; B67D 3/0041

(57) ABSTRACT

A method of measuring flow through an orifice includes flowing a fluid through the orifice, measuring a pressure drop across the orifice and a temperature of the fluid at one or more predetermined intervals, calculating an interval amount of flow of fluid through the orifice for each interval based on the measured pressure drop and temperature of the fluid, and summimg the calculated interval amounts of flow of fluid to determine an accumulated amount of fluid flow through the orifice.

### CROSS-REFERENCE TO RELATED APPLICATIONS

This application claims priority from U.S. Provisional Application No. 62/663,494, filed on Apr. 27, 2018, the entirety of which is hereby fully incorporated by reference herein.

### BACKGROUND

Exemplary embodiments pertain to the art of fluid flow measurement and mixing control. More particularly, the present disclosure relates to mixing of fluids in a frozen beverage machine.

Frozen beverage machine (including frozen carbonated beverage (FCB) machines) introduce a mixture of fluids, for example, syrup and water, into a freezing cylinder. The freezing cylinder chills or freezes the mixture to a desired temperature and consistency and the chilled mixture is dispensed through a dispensing mechanism of the frozen beverage machine.

In frozen beverage machines, it is desired to accurately control a ratio of the fluids that are present in the mixture. Typical flow control devices have assemblies that rely on an adjustable spring force acting on a sliding ceramic piston to create a variable orifice. The flow control device is manually adjusted by a technician, and the result is may be erroneous depending on the manual adjustment. Other systems utilize pulse width modulation (PWM) control of the flow. The accuracy of this control, however, depends the pressure drop across the valving of the system being constant.

### BRIEF DESCRIPTION

In one embodiment, a method of measuring flow through an orifice includes flowing a fluid through the orifice, measuring a pressure drop across the orifice and a temperature of the fluid at one or more predetermined intervals, calculating an interval amount of flow of fluid through the orifice for each interval based on the measured pressure drop and temperature of the fluid, and summing the calculated interval amounts of flow of fluid to determine an accumulated amount of fluid flow through the orifice.

Additionally or alternatively, in this or other embodiments the accumulated amount of fluid flow is compared to a selected flow amount, and the flow of fluid through the orifice is stopped when the accumulated amount is equal to or greater than the selected flow amount.

Additionally or alternatively, in this or other embodiments the one or more predetermined intervals is between 1 millisecond and 20 milliseconds.

Additionally or alternatively, in this or other embodiments the interval amounts and accumulated amounts are one of masses or volumes of fluid.

In another embodiment, a method of operating a frozen beverage machine includes determining an amount of a first fluid to be dispensed, opening a first valve to flow the first fluid therethrough toward a dispenser, measuring a pressure drop of the first fluid across the first valve and a temperature of the first fluid at the first valve at one or more preselected intervals, calculating an amount of flow of the first fluid through the second valve at each of the one or more preselected intervals, summing the calculated amounts of flow of the first fluid through the first valve to determine an accumulated flow of the first fluid, and stopping the flow of first fluid through the first valve when the accumulated flow of the first fluid is equal to or greater than the amount of first fluid to be dispensed.

Additionally or alternatively, in this or other embodiments an amount of a second fluid to be dispensed is determined, a second valve is opened to flow the second fluid therethrough toward the dispenser, a pressure drop of the second fluid across the second valve and a temperature of the second fluid at the second valve is measured at one or more preselected intervals, an amount of flow of the second fluid through the second valve at each of the one or more preselected intervals is calculated, the calculated amounts of flow of the second fluid through the second valve are summed to determine an accumulated flow of the second fluid, and the flow of second fluid through the second valve is stopped when the accumulated flow of the second fluid is equal to or greater than the amount of second fluid to be dispensed.

Additionally or alternatively, in this or other embodiments the second valve is opened after stopping the flow of the first fluid through the first valve.

Additionally or alternatively, in this or other embodiments a total dispense amount of a beverage comprising the first fluid and the second fluid is selected, a desired mix ratio of the first fluid to the second fluid in the beverage is determined, and the amount of first fluid to be dispensed and the amount of second fluid to be dispensed are determined based on the total dispense amount and the mix ratio.

Additionally or alternatively, in this or other embodiments the mix ratio is determined by a selected degrees Brix of the beverage.

Additionally or alternatively, in this or other embodiments the selected degrees Brix of the beverage is entered at a user interface operably connected to the first valve and the second valve.

Additionally or alternatively, in this or other embodiments the first fluid and the second fluid are mixed after dispensing the first fluid from the first valve and the second fluid from the second valve, and the mixed first fluid and second fluid are partially mixed at a freezing cylinder.

Additionally or alternatively, in this or other embodiments the first fluid is syrup and the second fluid is water.

Additionally or alternatively, in this or other embodiments the one or more preselected intervals are 10 milliseconds.

In yet another embodiment, a flow control unit for a beverage machine includes a housing having a fluid outlet, a first valve located in the housing and configured to selectably direct a first fluid therethrough toward the fluid outlet. A second valve is located in the housing and is configured to selectably direct a second fluid therethrough toward the fluid outlet. The first valve and the second valve are selectably operable to deliver a preselected amount of the first fluid and the second fluid through the fluid outlet, and an actual delivered amount of the first fluid is determined by a summation of first fluid amounts calculated at one or more selected intervals based on a pressure drop of the first fluid across the fluid outlet and a temperature of the first fluid measured at the one or more selected intervals.

Additionally or alternatively, in this or other embodiments a first pressure transducer located at the first valve is configured to measure a first fluid pressure at the first valve, and a first temperature sensor is configured to measure the temperature of the first fluid.

Additionally or alternatively, in this or other embodiments an actual delivered amount of the second fluid is determined by a summation of second fluid amounts calculated at the one or more selected intervals based on a pressure drop of the second fluid across the fluid outlet and a temperature of the second fluid measured at the one or more selected intervals.

Additionally or alternatively, in this or other embodiments a second pressure transducer located at the second valve is configured to measure a second fluid pressure at the second valve, and a second temperature sensor is configured to measure the temperature of the second fluid.

Additionally or alternatively, in this or other embodiments an outlet pressure transducer is utilized to determine the pressure drop of the first fluid across the fluid outlet.

Additionally or alternatively, in this or other embodiments the one or more selected intervals is one or more intervals of between 1 millisecond and 20 milliseconds.

### BRIEF DESCRIPTION OF THE DRAWINGS

The following descriptions should not be considered limiting in any way. With reference to the accompanying drawings, like elements are numbered alike:

FIG. 1 is a schematic illustration of an embodiment of a frozen beverage machine;

FIG. 2 is a schematic illustration of an embodiment of a fluid flow control unit; and

FIG. 3 is a schematic illustration of a method of operating a fluid flow control unit.

### DETAILED DESCRIPTION

A detailed description of one or more embodiments of the disclosed apparatus and method are presented herein by way of exemplification and not limitation with reference to the Figures.

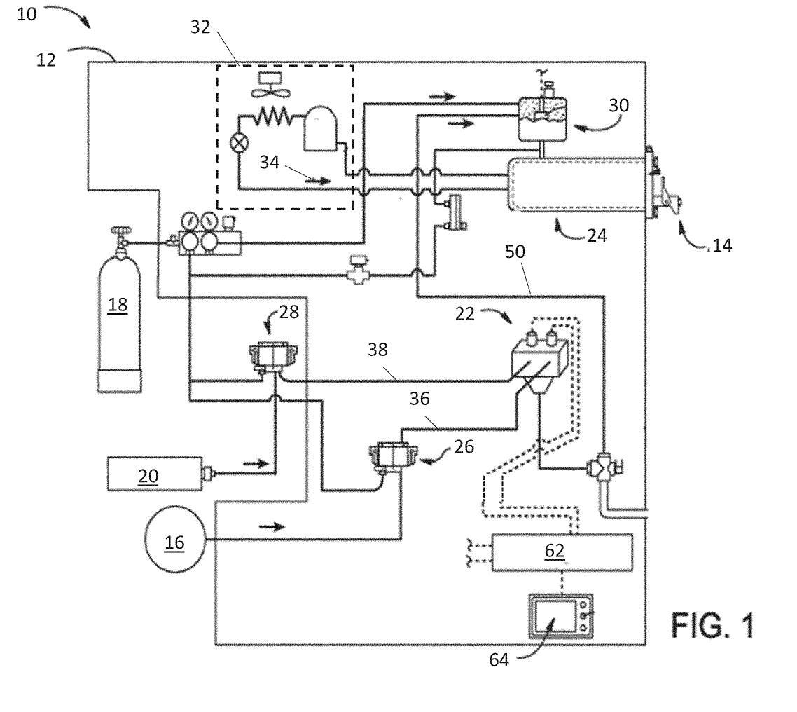

Referring now to FIG. 1, shown is a schematic illustration of a frozen beverage machine 10 having a housing 12 and a dispensing outlet 14. The machine 10 has external inputs of electricity (not shown) and potable water from a water supply 16 (e.g., from a building potable water supply). The machine 10 further includes an external input of pressurized carbon dioxide gas from a gas supply 18 (e.g., an external tank and regulator connected to an appropriate fitting on the machine 10). A further external input includes one or more sources of a flavored syrup from a syrup supply 20, such as a bag or a bin. Depending upon the particular implementation, the gas supply 18 and the syrup supply 20 may be located remote of the machine 10, such as in a service room, with the machine 10 being located behind a counter of a restaurant or along a buffet line, or the like.

A flow control unit 22 is operably connected to the water supply 16 via a water line 36 and to the syrup supply 20 via a syrup line 38 to direct a selected amount of water and syrup to a freezing cylinder 24. In some embodiments, the flow of water and syrup are via water pump 26 and syrup pump 28, respectively. The water pump 26 and the syrup pump 28 may be driven by pressurized gas from the gas supply 18. In some embodiments, the water and syrup are flowed into a reservoir, such as a mix tank 30, prior to introduction into the freezing cylinder 24. The syrup and water mixture is chilled or frozen at the freezing cylinder 24 and dispensed via the dispensing outlet 14. The freezing cylinder 24 is operably connected to a refrigeration unit 32, which directs a flow of refrigerant 34 to the freezing cylinder 24. The syrup and water mixture is chilled at the freezing cylinder 24 via thermal energy exchanged with the flow of refrigerant 34.

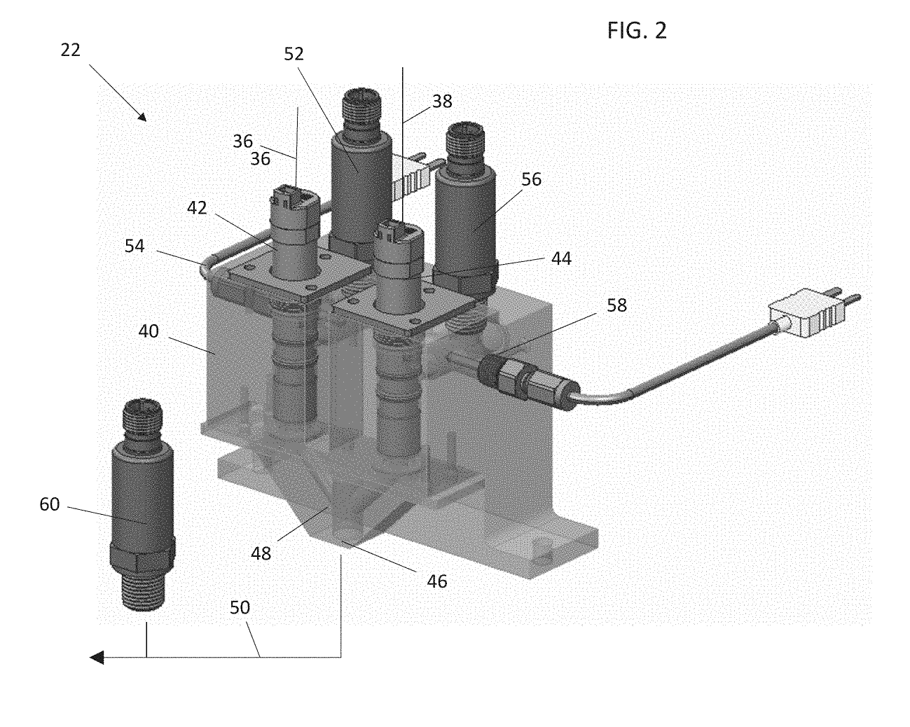

Referring now to FIG. 2, shown is an embodiment of the flow control unit 22. The flow control unit 22 includes a flow control unit housing 40 containing the various components of the flow control unit 22. The water line 36 extends to the flow control unit housing 40 and is connected to a water valve 42. Similarly, the syrup line 38 extends to the flow control unit housing 40 and is connected to a syrup valve 44. The water valve 42 and the syrup valve 44 are connected to a fluid outlet 46 via a fluid manifold 48, with passages extending from the water valve 42 and the syrup valve 44 to the fluid outlet 46. The water valve 42 and the syrup valve 44 may be fixed, or may be variable flow valves and/or utilize variable orifices. The fluid outlet 46 is connected to a fluid line 50, which connects the flow control unit 22 to the freezing cylinder 24, as best shown in FIG. 1.

Referring again to FIG. 2, the flow control unit 22 controls the flow of water and syrup therethrough via pressure drop and temperature data obtained at the flow control unit 22 by a plurality of sensors. A water pressure transducer 52 and a water temperature sensor 54 are disposed at the water valve 42 to detect a pressure and a temperature of the water at the water valve 42. Similarly, a syrup pressure transducer 56 and a syrup temperature sensor 58 are disposed at the syrup valve 44 to detect a pressure and a temperature of the syrup at the syrup valve 44. An outlet pressure transducer 60 is located to measure pressure of the fluid, either water or syrup or another fluid, at the fluid outlet 46. While in FIG. 2, the pressure transducer 60 is illustrated as being located along the fluid line 50, in other embodiments the pressure transducer 60 may be at other locations, such as in the flow control unit housing 40.

The pressure transducers 52, 56, 60 and the temperature sensors 54, 58 are connected to a system controller 62 (shown in FIG. 1) and the system controller 62 is connected to a user interface 64. The user interface 64 allows for a user to enter a desired sugar content, expressed as °Brix, a mixture ratio, a calibration offset value, and other parameters for operation of the machine 10 and the flow control unit 22.

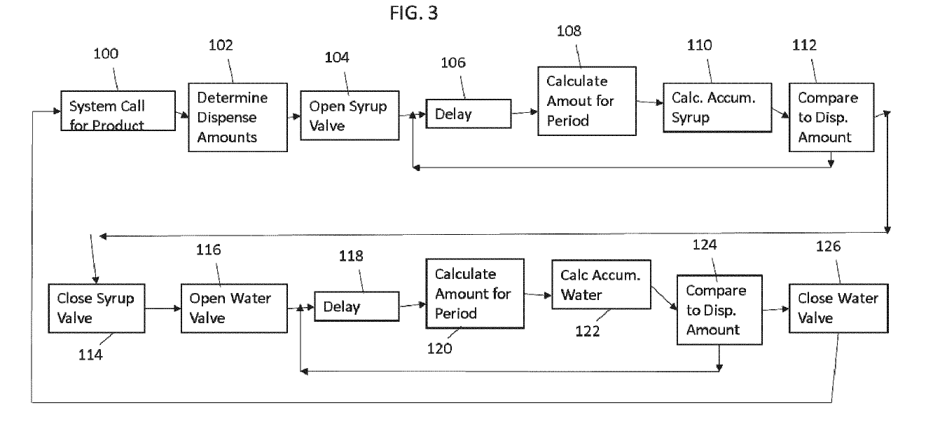

A method of operating the flow control valve 22 is illustrated in FIG. 3. At block 100, the system controller 62 signals a call for product to, for example, the mix tank 30 based on data from a level sensor at the mix tank 30. At block 102, the system controller 62 determines a total amount of fluid to be dispensed from the fluid outlet 46 based on, for example, the size of the mix tank 30. Utilizing a desired mix ratio based on a selected °Brix, the system controller 62 determines an amount of each of the water and syrup to be dispensed through the fluid outlet 46. The desired amount may be expressed in mass of each fluid or alternatively, in volume of each fluid. The water and syrup are dispensed through the fluid outlet one at a time beginning with, for example, syrup as illustrated in FIG. 3. It is to be appreciated that in other embodiments, the sequence may be reversed, with the water being dispensed before the syrup. At block 104, the syrup valve 44 is opened, allowing a flow of syrup to proceed from the syrup line 38 through the syrup valve 44, the fluid manifold 48 and the fluid outlet 46. The syrup then flows along the fluid line 50 to the mix tank 30. At block 106, the syrup valve 44 remains open for a preselected delay time period, for example 10 milliseconds.

After expiration of the delay time period, at block 108, data from the syrup pressure transducer 56, the syrup temperature sensor 58 and the outlet pressure transducer 60 are used to calculate a syrup flow rate and average amount of syrup dispensed over the delay time period utilizing the detected syrup temperature and a syrup pressure drop across the syrup valve 44. The average amount of syrup dispensed over the delay time period is used to calculate an accumulated amount of syrup dispensed at block 110, with the average amount of syrup dispensed over all delay time periods summed to determine the accumulated amount of syrup dispensed. At block 112, the accumulated amount of syrup dispensed is compared to the amount of syrup to be dispensed determined in block 102. If the accumulated amount of syrup dispensed is greater than or equal to the amount of syrup to be dispensed, the syrup valve 44 is closed at block 114. If that condition is not satisfied, the method returns to block 106, where the syrup is dispensed for another delay time period.

After the syrup valve 44 is closed at block 114, the water valve 42 is opened at block 116, in some embodiments after a brief delay time of 2 milliseconds. Opening of the water valve 42 allows a flow of water to proceed from the water line 36 through the syrup valve 42, the fluid manifold 48 and the fluid outlet 46. The water then flows along the fluid line 50 to the mix tank 30. At block 118, the water valve 42 remains open for a preselected delay time period, for example, 10 milliseconds. One skilled in the art will readily appreciate that other time delay periods, such as periods from 1 millisecond to 20 milliseconds or more may be utilized.

After expiration of the delay time period, at block 120, data from the water pressure transducer 52, the water temperature sensor 54 and the outlet pressure transducer 60 are used to calculate a water flow rate and average amount of water dispensed over the delay time period utilizing the detected water temperature and a water pressure drop across the water valve 42. The average amount of water dispensed over the delay time period is used to calculate an accumulated amount of water dispensed at block 122, with the average amount of water dispensed over all delay time periods summed to determine the accumulated amount of water dispensed. At block 124, the accumulated amount of water dispensed is compared to the amount of water to be dispensed determined in block 102. If the accumulated amount of water dispensed is greater than or equal to the amount of water to be dispensed, the water valve 42 is closed at block 126. If that condition is not satisfied, the method returns to block 118, where the water is dispensed for another delay time period.

While the flow control unit shown and described herein controls the flow of two fluids therethrough, one skilled in the art will readily appreciate that flow control units 22 controlling the flow of three or more fluids therethrough are contemplated by the present disclosure. Further, water and syrup are merely exemplary fluids to be flowed through the flow control unit 22. One skilled in the art will readily appreciate that the flow control unit 22 may be utilized to control the flow of other fluids. Additionally, in other embodiments the method disclosed herein may be utilized to report an instantaneous mass or flow rate of the fluid, and/or a moving or simple average of the volumes over multiple delay time periods.

The flow control unit 22 and method disclosed herein accounts for fluctuating temperatures and pressures across the valve as fluids are dispensed within the frozen beverage machine 10. Further, the method enables precise estimation of flow through a valve or orifice.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A method of measuring flow through an orifice, comprising:
flowing a fluid through the orifice;
measuring a pressure drop across the orifice and a temperature of the fluid at one or more predetermined intervals;
calculating an interval amount of flow of fluid through the orifice for each interval based on the measured pressure drop and temperature of the fluid; and
summing the calculated interval amounts of flow of fluid to determine an accumulated amount of fluid flow through the orifice.

2. The method of claim 1, further comprising:
comparing the accumulated amount of fluid flow to a selected flow amount; and
stopping the flow of fluid through the orifice when the accumulated amount is equal to or greater than the selected flow amount.

3. The method of claim 1, wherein the one or more predetermined intervals is between 1 millisecond and 20 milliseconds.

4. The method of claim 1, wherein the interval amounts and accumulated amounts are one of masses or volumes of fluid.

5. A method of operating a frozen beverage machine, comprising:
determining an amount of a first fluid to be dispensed;
opening a first valve to flow the first fluid therethrough toward a dispenser;
measuring a pressure drop of the first fluid across the first valve and a temperature of the first fluid at the first valve at one or more preselected intervals;
calculating an amount of flow of the first fluid through the second valve at each of the one or more preselected intervals;
summing the calculated amounts of flow of the first fluid through the first valve to determine an accumulated flow of the first fluid; and
stopping the flow of first fluid through the first valve when the accumulated flow of the first fluid is equal to or greater than the amount of first fluid to be dispensed.

6. The method of claim 5, further comprising:
determining an amount of a second fluid to be dispensed;
opening a second valve to flow the second fluid therethrough toward the dispenser;
measuring a pressure drop of the second fluid across the second valve and a temperature of the second fluid at the second valve at one or more preselected intervals;
calculating an amount of flow of the second fluid through the second valve at each of the one or more preselected intervals;
summing the calculated amounts of flow of the second fluid through the second valve to determine an accumulated flow of the second fluid; and
stopping the flow of second fluid through the second valve when the accumulated flow of the second fluid is equal to or greater than the amount of second fluid to be dispensed.

7. The method of claim 6, further comprising opening the second valve after stopping the flow of the first fluid through the first valve.

8. The method of claim 6, further comprising:
selecting a total dispense amount of a beverage comprising the first fluid and the second fluid;
determining a desired mix ratio of the first fluid to the second fluid in the beverage; and
determining the amount of first fluid to be dispensed and the amount of second fluid to be dispensed based on the total dispense amount and the mix ratio.

9. The method of claim 8, wherein the mix ratio is determined by a selected degrees Brix of the beverage.

10. The method of claim 9, further comprising entering the selected degrees Brix of the beverage at a user interface operably connected to the first valve and the second valve.

11. The method of claim 8, further comprising:
mixing the first fluid and the second fluid after dispensing the first fluid from the first valve and the second fluid from the second valve; and
at least partially freezing the mixed first fluid and second fluid at a freezing cylinder.

12. The method of claim 6, wherein the first fluid is syrup and the second fluid is water.

13. The method of claim 5, wherein the one or more preselected intervals are 10 milliseconds.

14. A flow control it for a beverage machine, comprising:
a housing having a fluid outlet;
a first valve disposed in the housing and configured to selectably direct a first fluid therethrough toward the fluid outlet;
a second valve disposed in the housing and configured to selectably direct a second fluid therethrough toward the fluid outlet;
wherein the first valve and the second valve are selectably operable to deliver a preselected amount of the first fluid and the second fluid through the fluid outlet; and
wherein an actual delivered amount of the first fluid is determined by a summation of first fluid amounts calculated at one or more selected intervals based on a pressure drop of the first fluid across the fluid outlet and a temperature of the first fluid measured at the one or more selected intervals.

15. The flow control unit of claim 14, further comprising:
a first pressure transducer disposed at the first valve configured to measure a first fluid pressure at the first valve; and
a first temperature sensor configured to measure the temperature of the first fluid.

16. The flow control unit of claim 14, wherein an actual delivered amount of the second fluid is determined by a summation of second fluid amounts calculated at the one or more selected intervals based on a pressure drop of the second fluid across the fluid outlet and a temperature of the second fluid measured at the one or more selected intervals.

17. The flow control unit of claim 16, further comprising:
a second pressure transducer disposed at the second valve configured to measure a second fluid pressure at the second valve; and
a second temperature sensor configured to measure the temperature of the second fluid.

18. The flow control unit of claim 14, further comprising an outlet pressure transducer utilized to determine the pressure drop of the first fluid across the fluid outlet.

19. The flow control unit of claim 14, wherein the one or more selected intervals is one or more intervals of between 1 millisecond and 20 milliseconds.
